(19) United States
(12) Patent Application Publication
(10) Pub. No.: US 2004/0047787 A1
(43) Pub. Date: Mar. 11, 2004

(54) Process for the selective oxidation of cabon monoxide

(76) Inventors: Michiel Jan Groeneveld, Amsterdam (NL); Gert Jan Kramer, CM Amsterdam (NL); Michael Johannes Franicscus Maria Verhaak, CM Amsterdam (NL)

Correspondence Address: Richard F Lemuth, Shell Oil Company, Intellectual Property, PO Box 2463, Houston, TX, 77252-2463, US

(21) Appl. No.: 10/257,817

(22) PCT Filed: Apr. 11, 2001
(86) PCT No.: PCT/EP01/04332

(30) Foreign Application Priority Data
Apr. 14, 2000 (EP) 00303187.9

(51) Int. Cl. B01D 53/62

(52) U.S. Cl. 423/247; 422/222; 422/211

(57) ABSTRACT

A process for the selective oxidation of carbon monoxide in a hydrogen-rich gas stream, wherein a mixture comprising the hydrogen-rich gas stream and a molecular oxygen-containing gas is contacted with a monolithic structure of a material having a thermal conductivity of at least 30 W/m.K, which monolithic structure is provided with a catalyst for the selective oxidation of carbon monoxide, at a gas velocity such that the flow through the monolithic structure is laminar. The invention further relates to a reactor comprising such a monolithic structure, wherein particles of the catalyst are contained in the monolithic structure.

The present invention relates to a process for the selective oxidation of carbon monoxide in a hydrogen-rich gas stream, wherein a mixture comprising the hydrogen-rich gas stream and a molecular oxygen-containing gas is contacted with a monolithic structure of a material having a thermal conductivity of at least 30 W/m.K, which monolithic structure is provided with a catalyst for the selective oxidation of carbon monoxide, at a gas velocity such that the flow through the monolithic structure is laminar. The invention further relates to a reactor comprising such a monolithic structure, wherein particles of the catalyst are contained in the monolithic structure.

In order to convert a hydrocarbonaceous fuel into energy by means of a fuel cell, the fuel first has to be converted into a hydrogen-containing gas that can be fed to the fuel cell. The conversion of fuel into hydrogen-containing gas is performed in a so-called fuel processor. Recently proposed fuel processors are based on a steam reforming reaction, partial oxidation or a combination thereof. Reference is made for example to WO 99/48805, wherein a process for the catalytic generation of hydrogen from hydrocarbons that combines steam reforming and partial oxidation has been disclosed.

However, the carbon monoxide concentration of the product gas of the steam reforming or partial oxidation reaction is generally too high for direct conversion in a proton exchange membrane (PEM) fuel cell, which is a promising type of fuel cell for small-scale applications. The catalyst of a PEM fuel cell is poisoned by carbon monoxide. Therefore, the carbon monoxide content of the hydrogen-containing gas to be fed to a PEM fuel cell should be below 100 ppm, preferably below 50 ppm or even more preferably below 20 ppm.

If fuel is to be converted for subsequent use in a PEM fuel cell, the partial oxidation or reforming reaction is usually followed by a water-gas shift reaction

CO+H₂O→CO₂+H₂

to convert the greater part of the remaining carbon monoxide into carbon dioxide, while concurrently producing hydrogen. The then still remaining carbon monoxide, typically up to 0.5% by volume, is selectively oxidised, i.e. with minimising oxidation of hydrogen, according to the reaction

CO+1/2O₂→CO₂

Selective oxidation of carbon monoxide is performed by contacting a mixture of a hydrogen-rich gas stream and a molecular oxygen containing gas, suitably air, with a suitable catalyst. Suitable catalysts are known in the art, for example from U.S. Pat. No. 3,216,782, U.S. Pat. No. 3,216,783 and WO 00/17097, and typically comprise a noble metal on a refractory oxide catalyst carrier. In the prior art, the catalyst is usually in the form of a fixed bed of catalyst carrier particles, such as pellets, powder or granules.

The operating temperature for the selective oxidation depends inter alia on the catalyst used and the desired conversion rate. Operating temperatures are typically in the range of from 80 to 200° C. In order to achieve a high selectivity, it is important that temperature gradients within the catalyst bed are minimised. For example, in the case that the inlet gas stream has a carbon monoxide concentration of approximately 10.000 ppm and the desired outlet concentration is at most 50 ppm, a carbon monoxide conversion of at least 99.5% is required. For a specific catalyst, the temperature operating window wherein such a conversion can be achieved has generally a width of approximately 20° C. Ideally, the selective oxidation reaction is operated isothermally.

Due to the exothermic nature of the selective oxidation reaction and of the concurrent oxidation of hydrogen, the temperature of the catalyst bed will typically increase in axial direction from the upstream to the downstream side, if no internal cooling of the catalyst bed is applied. Especially in the case of a fixed bed of ceramic catalyst carrier particles, such as used in the prior art selective oxidation processes, temperature rises of more than 20° C. can easily occur, resulting in loss of selectivity.

In U.S. Pat. No. 5,674,460, a reactor for the selective oxidation of carbon monoxide is described wherein steep temperature gradients are avoided by generating a turbulent fluid flow. The turbulent flow is generated by arranging a three dimensional structure within a flow path of the reactor. An exemplified three dimensional structure is a commercially available metal cross-channel structure (ex. Sulzer) on which the catalyst, i.e. a noble metal on a refractory oxide catalyst carrier, is coated.

Under turbulent flow condition, however, the pressure drop over the catalyst bed is relatively large. Especially if selective oxidation is applied in small-scale systems, such as a fuel processor/fuel cell system for domestic generating of heat and power, operating pressures are low and large pressure drops are unwanted.

It has now been found that, under laminar flow conditions, temperature gradients in a catalyst bed for the selective oxidation of carbon monoxide can be minimised without applying internal cooling of the catalyst bed, by using a monolithic structure consisting of a material having a high thermal conductivity as catalyst support.

Accordingly, the present invention relates to a process for the selective oxidation of carbon monoxide in a hydrogen-rich gas stream, wherein a mixture comprising the hydrogen-rich gas stream and a molecular oxygen-containing gas is contacted with a monolithic structure of a material having a thermal conductivity of at least 30 W/m.K, which monolithic structure is provided with a catalyst for the selective oxidation of carbon monoxide, at a gas velocity such that the flow through the monolithic structure is laminar.

Fluid flow through a structure is laminar if the Reynolds number is below the critical Reynolds number. Determination of the critical Reynolds number is known in the art and can for example be deduced from the relationship between the pressure drop over the structure and the superficial or linear velocity of the fluid.

Preferably, the superficial gas velocity of the mixture comprising the hydrogen-rich gas stream and the molecular oxygen-containing gas is at most 2 m/s when contacting the monolithic structure, more preferably at most 1.5 m/s, even more preferably at most 1.0 m/s.

Reference herein to a monolithic structure is to any single porous material unit in which the pores constitute straight or tortuous, parallel or random elongate channels extending through the monolithic structure. Suitable monolithic structures are for example honeycombs, foams, or arrangements of metal wires, gauzes or foils. Preferably, the monolithic structure has open connections between the different channels in lateral direction, such that feed and reaction gases from different channels can mix with each other, thereby minimising concentration and temperature gradients. Examples of monolithic structures having open connections in lateral direction are foams and wire arrangements. Honeycombs are an example of monolithic structures not having such open connections in lateral direction. Particularly preferred monolithic structures are foams.

The monolithic structure of the reactor of the invention may be made of any material having a thermal conductivity of at least 30 W/m.K (watts per metre Kelvin), preferably at least 80 W/m.K, more preferably at least 150 W/m.K. Reference to the thermal conductivity of the monolithic structure material is to the bulk thermal conductivity of the material of which the monolithic structure is manufactured, and not to the thermal conductivity of the monolithic structure. Preferred materials are silicon carbides or metals. More preferred monolithic structure materials are metals, most preferably metal alloys, in particular aluminium-containing alloys, for example high-temperature resistant alloy steels such as Fecralloy or PM 2000 (both Fecralloy and PM 2000 are a trademark).

The monolithic structure is the support for the catalyst. These catalysts typically comprise at least one catalytically active metal, preferably a noble metal on a catalyst carrier. Preferred catalyst carriers are refractory oxide carriers, more preferably alumina, even more preferably alpha-alumina. Preferred noble metals are Pt and/or Ru. Typically, the concentration of noble metal based on the weight of catalyst carrier is in the range of from 0.05 to 10% by weight, more preferably 0.1 to 5% by weight.

The monolithic structure may be provided with the catalyst in any suitable manner. Preferably, the catalyst is coated on the monolithic structure or is contained in the pores or channels of the monolithic structure. More preferably, the catalyst is coated on the monolithic structure.

Preferably, the monolithic structure is in thermal contact with a wall of the reactor in which it is contained, such that substantially no heat resistance between the monolithic structure and the reactor wall exists and conductive removal of heat from the monolithic structure is facilitated. Thermal contact may, for example, be achieved by clamping or welding the monolithic structure to a reactor wall.

If the monolithic structure is a foam, the number of pores in the foam is, in order to have sufficient surface area to be provided with catalyst, preferably at least 4 per cm (10 pores per inch (ppi)), more preferably at least 8 per cm (20 ppi). Since a larger number of pores corresponds to a smaller size of the pore dimensions, the number of pores in the foam is preferably at most 40 per cm (100 ppi), more preferably at most 25 per cm (65 ppi), in order to avoid a large pressure drop over the foam.

The void fraction of the monolithic structure is preferably in the range of from 0.4 to 0.98, more preferably of from 0.6 to 0.95.

The monolithic structure of the process according to the invention may be part of a reactor for the selective oxidation of carbon monoxide in a hydrogen-rich gas stream. Alternatively, the monolithic structure may be part of a fuel processor comprising a reaction zone for the selective oxidation of carbon monoxide. Typically, such a fuel processor comprises the following reaction zones:

(a) a reaction zone for the generation of a first product gas comprising carbon monoxide and hydrogen by means of partial oxidation and/or steam reforming of a hydro-carbonaceous fuel;

(b) a reaction zone for the water-gas shift conversion of the carbon monoxide in the first product gas; and

(c) a reaction zone for the selective oxidation of the remaining carbon monoxide.

If the carbon monoxide concentration in the first product gas is sufficiently low, for example below 1% by volume, reaction zone (b) may be omitted. The reactor or the fuel processor may comprise more than one monolithic structures as hereinbefore defined.

The invention further relates to a reactor comprising a monolithic structure of a material having a thermal conductivity of at least 30 W/m.K, wherein particles of a catalyst for the selective oxidation of carbon monoxide in a hydrogen-rich gas stream are contained in the monolithic structure.

The invention will now be illustrated by means of the following examples.

### EXAMPLES

### Example 1

### According to the Invention

A cylindrical piece (height: 400 mm; diameter: 57 mm) of a foam of aluminium alloy (6101 aluminium alloy, DUOCEL 40 ppi (DUOCEL is a trademark), ex. ERG, Oakland, USA) was coated with a catalyst comprising Pt and Ru on alpha-alumina. The coated foam comprised 62 grams of catalyst. The uncoated foam had an average pore diameter of 2.9 mm and a void fraction of 0.93.

The coated foam was placed in a reactor tube. A stream of 80 Nl/min of a gas mixture having a composition as given in Table 1 was contacted with the coated foam. The superficial gas velocity of the gas mixture was 1.2 m/s. The temperature of the gas mixture at the inlet of the foam was varied between 120 and 140° C. For each inlet temperature, the temperature difference between the reactor wall and the middle of the foam was determined at several heights of the foam, and the carbon monoxide concentration at the outlet of the foam was determined. In Table 2, the maximum temperature difference measured and the carbon monoxide concentration at the outlet is given.

For the foam used in this example, the transition from laminar to turbulent flow was determined to occur at a superficial gas velocity above 4 m/s.

### Example 2

### Comparative

A catalyst bed was prepared containing 60 g of catalyst particles (1.2 mm diameter spheres) having the same composition as the catalyst used in example 1 and 60 g of alpha-alumina particles (1.2 mm diameter spheres). The height of the bed was 116 mm and the rectangular cross-section had a width of 10 mm and a length of 120 mm.

A stream of 80 Nl/min of a gas mixture having a composition as given in Table 1 was contacted with the catalyst bed. The gas mixture temperature at the inlet was varied as in example 1 and the temperature difference between the wall and the middle of the catalyst bed was determined at different heights of the catalyst bed. The results are given in Table 2.

TABLE 1

| Composition gas mixture | | Example 2 |
|---|---|---|
| (% by volume) | Example 1 | (comparative) |
| CO | 0.29 | 0.26 |
| O₂ | 0.58 | 0.52 |
| H₂ | 39 | 40 |
| H₂O | 14.6 | 13 |
| CO₂ | 14.6 | 15 |
| N₂ | 30.9 | 31.2 |

TABLE 2

| | |
|---|---|
| | Example 2 |
| Example 1 | (comparative) |

| | | CO conc. | | CO conc. |
|---|---|---|---|---|
| T gas at | ΔT | outlet | ΔT | outlet |
| inlet (° C.) | (° C.) | (ppmv) | (° C.) | (ppmv) |
| 120 | 2 | 9 | 50 | 29 |
| 130 | 14 | 12 | 57 | 40 |
| 140 | 14 | 14 | 60 | 87 |

The examples show that the temperature gradients in the catalyst bed of example 1 are lower than those in the catalyst bed of example 2, resulting in a higher carbon monoxide conversion in example 1 as compared to example 2.

1. A process for the selective oxidation of carbon monoxide in a hydrogen-rich gas stream, wherein a mixture comprising the hydrogen-rich gas stream and a molecular oxygen-containing gas is contacted with a monolithic structure of a material having a thermal conductivity of at least 30 W/m.K, which monolithic structure is provided with a catalyst for the selective oxidation of carbon monoxide, at a gas velocity such that the flow through the monolithic structure is laminar.

2. A process according to claim 1, wherein the superficial gas velocity of the mixture of hydrogen-rich gas stream and molecular oxygen-containing gas is at most 2 m/s, preferably at most 1.5 m/s.

3. A process according to claim 1 or 2, wherein the catalyst is coated on the monolithic structure.

4. A process according to claim 1 or 2, wherein the catalyst is in the form of particles which are contained in the monolithic structure.

5. A process according to any of the preceding claims, wherein the monolithic structure material has a thermal conductivity of at least 80 W/m.K, preferably at least 150 W/m.K.

6. A process according to any of the preceding claims, wherein the monolithic structure material is a metal, preferably an aluminium-containing alloy.

7. A process according to any of claims 1 to 5, wherein the monolithic structure material is a silicon carbide.

8. A process according to any of the preceding claims, wherein the monolithic structure is contained in a reactor and has thermal contact with a wall of the reactor.

9. A process according to any of the preceding claims, wherein the monolithic structure is a foam.

10. A process according to claim 9, wherein the foam has a number of pores per cm of at least 4 (10 ppi), preferably at least 8 (20 ppi), and at most 40 (100 ppi), preferably at most 25 (65 ppi).

11. A process according to any of the preceding claims, wherein the monolithic structure has a void fraction in the range of from 0.4 to 0.98, preferably of from 0.6 to 0.95.

12. A process according to any of the preceding claims, wherein the catalyst comprises a noble metal supported on a refractory oxide carrier material.

13. A process according to claim 12, wherein the refractory oxide carrier material is alumina, preferably alpha-alumina.

14. A process according to claim 12 or 13, wherein the noble metal is at least one metal selected from Ru and Pt.

15. A reactor comprising a monolithic structure of a material having a thermal conductivity of at least 30 W/m.K, wherein particles of a catalyst for the selective oxidation of carbon monoxide in a hydrogen-rich gas stream are contained in the monolithic structure.

16. A reactor according to claim 15, wherein the monolithic structure material has a thermal conductivity of at least 80 W/m.K, preferably at least 150 W/m.K.

17. A reactor according to claim 15 or 16, wherein the monolithic structure material is a metal, preferably an aluminium-containing alloy.

18. A reactor according to claim 15 or 16, wherein the monolithic structure material is a silicon carbide.

19. A reactor according to any of claims 15 to 18, wherein the monolithic structure is a foam.
